(19) United States
(12) Patent Application Publication
(10) Pub. No.: US 2006/0279709 A1
(43) Pub. Date: Dec. 14, 2006

(54) Light source device and projection optical device

(75) Inventor: Makoto Yamamoto, Kanagawa (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/445,092

(22) Filed: Jun. 1, 2006

(30) Foreign Application Priority Data
Jun. 8, 2005 (JP) 2005-168360

(51) Int. Cl. G03B 21/20

(52) U.S. Cl. 353/85

(57) ABSTRACT

There is provided a light source device comprising: a video type detection section that detects a type of an input video signal; a plurality of light emitting diodes that irradiate illumination light; and a lighting control section that controls a lighting status of the light emitting diodes, wherein the lighting control section performs lighting control of the light emitting diodes, based on a type of a video signal as detected by the video type detection section.

### BACKGROUND OF THE INVENTION

1. Field of the Invention

The present invention relates to a light source device and a projection optical device used for a projector that displays an image on a projection surface, that support, in particular, input video signals having various rates.

This application is based on Japanese Patent Application No. 2005-168360, the content of which is incorporated herein by reference.

2. Description of Related Art

In recent years, in a small projector, a spatial light modulation element such as a DMD (Digital Micromirror Device) element that modulates illumination light by switching minute mirrors of respective pixels arranged in a matrix, to angles of ON and OFF status at high speed by PMW(Pulse Width Modulation) drive according to image data, has come into use.

Since a spatial light modulation element differs from a conventional liquid crystal display element and enables high speed operation, images of R (red), G (green) and B (blue) can be displayed in a frame sequential mode. Moreover, whereas a projector using a liquid crystal display element requires three LCD (Liquid Crystal Display) elements for displaying a color image, a projector that uses a spatial light modulation element can carry out color display with one DMD element.

In a projector that uses such a spatial light modulation element, a white light lamp such as a mercury lamp is conventionally used as a light source. That is to say, in a projector that uses a conventional spatial light modulation element, an input video signal is converted into a frame sequential image signal and supplied to the spatial light modulation element, and a colored wheel colored in RGB is rotated in synchronization with the vertical synchronization signal of the input image, or the rate of the video signal synchronized to the rotation of the colored wheel is changed, to irradiate the light from the lamp on the spatial light modulation element through the colored wheel. However, when a lamp is used as a light source of a projector, power consumption becomes significant, and also a colored wheel is required.

On the other hand, use of a LED as a light source for such a projector has been considered in recent years. Compared with a lamp, a LED has the advantages of smaller size, greater durability, longer operating life, and lower power consumption. Moreover, when three colored LEDs are used, the colored wheel is no longer required, and excellent color reproduction can be achieved. Furthermore, in the case where the spatial light modulation element is used, since it does not have the polarization dependence that is observed in a liquid crystal display element, an optical system with a small loss with respect to a light source that emits non-polarized light, such as a LED, can be easily configured.

However, in the case where a LED is direct current driven, the electric current that can be applied to the LED is limited. Therefore, the present applicant proposes to use a rotating optical system in which a plurality of LEDs are arranged in a circle, as disclosed in Japanese Unexamined Patent Application, First Publication No. 2003-346503, Japanese Unexamined Patent Application, First Publication No. 2004-102132 and Japanese Unexamined Patent Application, First Publication No. 2004-199024.

In such a rotating optical system, a plurality of RGB LEDs are arranged in a circle, and a rod of the optical system that rotates along this plurality of the LEDs is provided. The plurality of LEDs is sequentially pulse driven so that the plurality of LEDs is sequentially pulse lighted. Moreover, the rod of the optical system rotates with the lighting of the LEDs, and the lights of the LEDs are collected while the LEDs are ON, and are irradiated on the spatial light modulation element.

There is a limit to the electric current that can be applied to the LED when the LED is direct current driven. However, when the rotating optical system is used, the LED is pulse driven as mentioned above. As a result, high electric current can be applied to the LED and intense light emission can be achieved. Also since the light of the LEDs while lit is collected by the rod of the optical system when such a rotating optical system is used, it is equivalent to a continuous lighting of the LEDs.

In such a projector, an RGB color video signal from a personal computer or the like, and a color video signal such as NTSC (National Television System Committee) format are inputted. For example, polarities, timing, and frequencies of a horizontal synchronization signal and a vertical synchronization signal of an analog RGB video signal from a personal computer are defined according to the resolution of that output video signal, by VESA (Video Electronics Standards Association).

However, some personal computers output a video signal having nonstandard polarity or timing in some cases. Therefore, such a projector needs to be able to support a video signal having non-standard polarity or timing.

Moreover, since various kinds of video signals are inputted in such a projector, it follows that light emission timing and light emission time of the LEDs, and phase and number of revolutions of the optical rod need to be set accordingly.

Furthermore, in such a projector, various kinds of problems are assumed to arise such as during startup when controlling a motor to rotate the optical rod to reach a desired number of revolutions in accordance with the input video signal rate, or when the form of the input signal changes in mid course, or when the input signal is not present.

### BRIEF SUMMARY OF THE INVENTION

In consideration of the heretofore known problems described above, an object of the present invention is to provide a light source device and a projection optical device able to flexibly adapt to video signals having various kinds of signal rates, including a video signal of non-standard polarity and timing.

A first aspect of the present invention is a light source device comprising: a video type detection section that detects a type of an input video signal; a plurality of light emitting diodes that irradiate illumination light; and a lighting control section that controls a lighting status of the light emitting diodes, wherein the lighting control section performs lighting control of the light emitting diodes, based on a type of a video signal as detected by the video type detection section.

In the aforementioned light source device, the video type detection section may extract a synchronization signal of the input video signal, and determine the type of the input video signal, based on the cycle of the synchronization signal of the input video signal.

In the aforementioned light source device, the video type detection section may extract a synchronization signal of the input video signal, and determine the type of the input video signal, based on a duty ratio of the synchronization signal of the input video signal.

The aforementioned light source device may comprise: an optical rod that takes in illumination light irradiated from a plurality of light emitting diodes arranged on a periphery; a motor that rotates the optical rod; and a rotation control section that controls the rotation of the motor, and the rotation of the optical rod may be controlled based on a detection output of the video type detection section.

In the aforementioned light source device, the rotation control section may control the motor so that the optical rod rotates an integral number of times within a period of two vertical cycles, taking a two vertical cycles period of the input video signal as a unit.

In the aforementioned light source device, the lighting control section may control the light emitting diodes so that an emitted light amount becomes substantially equal across units of the period of two vertical cycles of the input video signal.

In the aforementioned light source device, the rotation control section may have a detection section that detects a tracking status of rotation of the rod with respect to a synchronization signal, and the plurality of the light emitting diodes may be turned off in a case where the detection section has determined that a number of revolutions of the optical rod is below a predetermined number of revolutions.

In the aforementioned light source device, the lighting control section may control timing for turning on the light emitting diodes, and lighting time duration of the light emitting diodes, based on the type of the video signal.

In the aforementioned light source device, the lighting control section may have a free running vertical synchronization signal generation section that generates a free running vertical synchronization signal having a fixed rate or a rate of a previous video signal, and in a case where an input signal is not present, the optical rod may be rotated based on the free running vertical synchronization signal from the free running vertical synchronization signal generation section.

In the aforementioned light source device, the rotation control section may stop rotation of the optical rod when rotation of the optical rod is not stable.

A second aspect of the present invention is a projection optical device comprising: a video type detection section that detects a type of an input video signal; a plurality of light emitting diodes that irradiate illumination light; a lighting control section that controls a lighting status of the light emitting diodes; a driving signal control section that generates a driving signal based on an input video signal; and a spatial light modulation element that is driven by a driving signal from the driving signal control section, wherein the lighting control section performs lighting control of the light emitting diodes based on a type of a video signal detected by the video type detection section.

The aforementioned projection optical device may have a detection section that detects a tracking status of rotation of an optical rod with respect to a synchronization signal, and in a case where an input video signal is not present, or where the detection section has determined a number of revolutions of the optical rod to be unusual, a predetermined image is projected on the spatial light modulation element regardless of a synchronization signal status.

The present invention can be widely used for projectors that use LEDs as light sources.

According to the present invention, the type of the input video signal is determined, and based on this input video signal type, the number of revolutions of the optical rod, and lighting timing and lighting time duration of the light source are adaptively set. As a result, a projection optical device that can flexibly adapt to video signals of various kinds of signal rates can be realized.

According to the present invention, by determining the input video signal type from cycles of the horizontal synchronization signal and the vertical synchronization signal, and from the duty ratio of the horizontal synchronization signal and the vertical synchronization signal of the input video signal, the type of the video signal, including video signals of non-standard polarities and timings, can be appropriately determined.

According to the present invention, as a result of setting the period of two vertical cycles of the input video signal as a unit of light emission of the light source and the rotation of the optical rod, the emitted light amount within the two cycles period becomes equal, and luminance variance does not occur even when the type of the input video signal switches.

According to the present invention, in the case where the number of revolutions of the optical rod has been determined to be below the predetermined number of revolutions, display of a disturbed image can be prevented by turning off the plurality of the light sources.

According to the present invention, by controlling not only the light emitting timing of the light source but also the lighting time duration of the light source, the total emitted light amount within a predetermined period can be appropriately set, and an image having no luminance variance according to the input video signal rate can be projected without the occurrence of color shift.

According to the present invention, in the case where the input signal is not present, the optical rod rotates based on the free running vertical synchronization signal from the free running vertical synchronization signal generation section. Therefore even when an input signal becomes absent, the number of revolutions of the motor is maintained appropriately, and the time required for resuming projection of a new image can be reduced. Furthermore, light emission of the LEDs is not disturbed, resulting in preservation and longer operating life of the LEDs.

According to the present invention, by stopping rotation of the motor when the motor is unable to reach the predetermined number of revolutions, power saving can be achieved.

According to the present invention, by projecting a masking signal or predetermined pattern image from a pattern generation section in the case where the input signal is absent or the number of revolutions of the optical rod differs from the usual, OSD (On Screen Display) can be performed without displaying a disturbed image.

### BRIEF DESCRIPTION OF THE SEVERAL VIEWS OF THE DRAWINGS

FIG. 1 is a block diagram showing an overall configuration of a projector to which the present invention is applied.

FIG. 2 is a block diagram showing a configuration of a rotating optical system in a projector to which the present invention is applied.

FIG. 3 is a block diagram showing an example of a video type detection circuit in a projector to which the present invention is applied.

FIG. 4 is a block diagram showing an example of an LED control and motor control circuit in a projector to which the present invention is applied.

FIG. 5 is a timing diagram for describing LED control in a projector to which the present invention is applied.

FIG. 6 is a timing diagram for describing LED control in a projector to which the present invention is applied.

FIG. 7 is a timing diagram for describing LED control in a projector to which the present invention is applied.

FIG. 8 is a timing diagram for describing LED control in a projector to which the present invention is applied.

FIG. 9 is a timing diagram for describing motor control in a projector to which the present invention is applied.

FIG. 10 is a block diagram for describing an example of LED turn-off control in a projector to which the present invention is applied.

FIG. 11 is a block diagram for describing another example of LED turn-off control in a projector to which the present invention is applied.

FIG. 12 is a block diagram for describing an example of motor stopping control in a projector to which the present invention is applied.

FIG. 13 is a block diagram for describing a free-running synchronization signal in a projector to which the present invention is applied.

FIG. 14 is a block diagram for describing projection of a fixed pattern screen in a projector to which the present invention is applied.

### DETAILED DESCRIPTION OF THE INVENTION

Hereinafter, an embodiment of the present invention is described, with reference to the drawings.

1. Overall Configuration

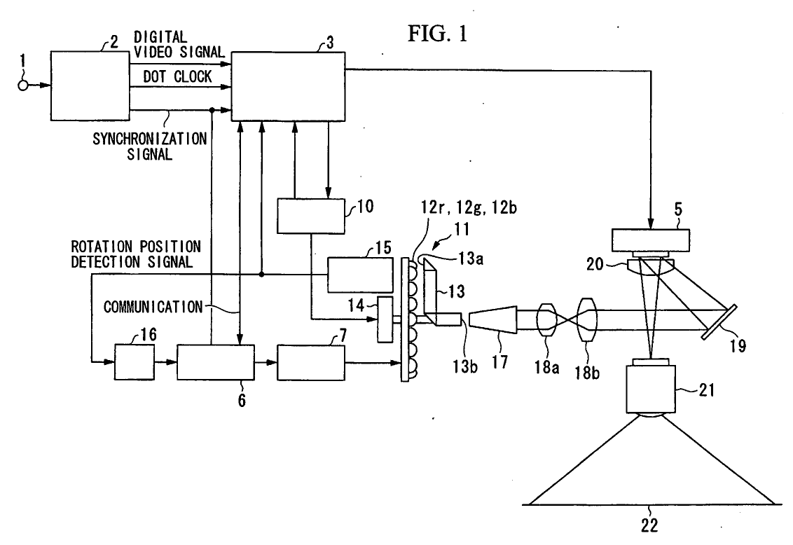

FIG. 1 shows a configuration of a projector to which the present invention is applied. In FIG. 1, a R (red), G (green), and B (blue) color video signal or an NTSC format color video signal from a personal computer or the like, is supplied to an input terminal 1.

A video signal processing circuit 2 performs predetermined video signal processing for the input video signal in accordance with the form thereof. In the case where the input video signal is an RGB color video signal, the video signal processing circuit 2, A/D converts and digitalizes the input video signal and outputs it. In the case where the input video signal is an NTSC color video signal or the like, the video signal processing circuit 2 separates the input video signal into a luminance signal Y and a color-difference signal UV by means of YC separation, and then A/D converts and digitalizes the input video signal and outputs it.

A DMD drive control circuit 3 is a processing circuit in which a signal processing circuit for DMD driving and a CPU that controls the overall circuit, are integrated into one chip. Moreover, the DMD drive control circuit 3 includes an OSD (On Screen Display) circuit that overlays and displays; a set channel, a volume, or various kinds of control status or warning information, on a screen.

In the DMD drive control circuit 3, signal processing such as IP conversion, scaling, color conversion, and trapezoidal correction are performed on the digital data for the luminance Y and the color difference UV, or RGB digital video data, from the video signal processing circuit 2. Here, IP conversion is a conversion from interlace scanning into progressive scanning. The DMD drive control circuit 3 outputs an RGB frame sequential image signal based on the input signal. The frame sequential image signal is a signal in which the video signal of each of the RGB colors is divided into emission periods of R emission period, G emission period, and B emission period. This frame sequential image signal is supplied as a DMD driving signal to a DMD element 5.

The DMD element 5 is a spatial light modulation element that has a number of minute mirrors disposed on the surface thereof, the angles of the mirrors being changeable with respect to each pixel. When the DMD driving signal from the DMD drive control circuit 3 is given to the DMD element 5, the angles of the minute mirrors on the surface of the DMD element 5 change, consequently changing the path of the light to perform ON/OFF of the light for each pixel.

Moreover, a motor driving signal is generated in the DMD drive control circuit 3 based on a synchronization signal of the input video signal. This motor driving signal is supplied to a motor driving circuit 10. As a result, a motor 14 disposed on a rotating optical system 11 rotates based on the vertical synchronization signal of the input video signal.

The DMD drive control circuit 3 and a timing generation circuit 6 perform two-way communication. A reference clock is generated by a PLL (Phase Locked Loop) circuit 16 based on a rotation position detection signal from a rotation detection sensor 15. An LED lighting pulse is generated by the timing generation circuit 6 according to this reference clock. This LED lighting pulse is supplied to a LED driving circuit 7. A driving electric current is allowed to flow at a predetermined timing to a plurality of LEDs 12r, 12g, and 12b disposed on the rotating optical system 11 by the LED driving circuit 7. As a result, the plurality of the LEDs 12r, 12g, and 12b light in sequence based on the vertical synchronization signal of the input video signal.

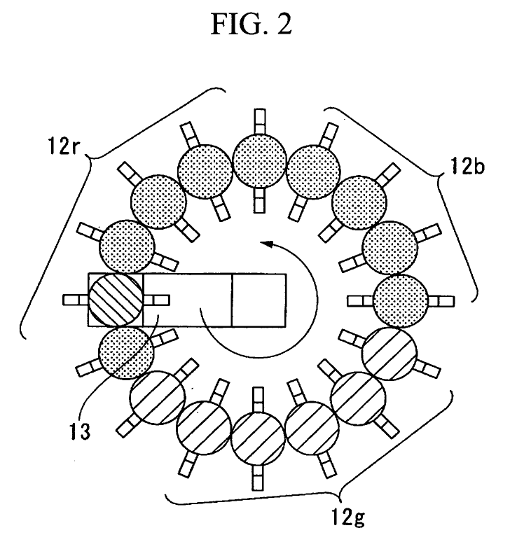

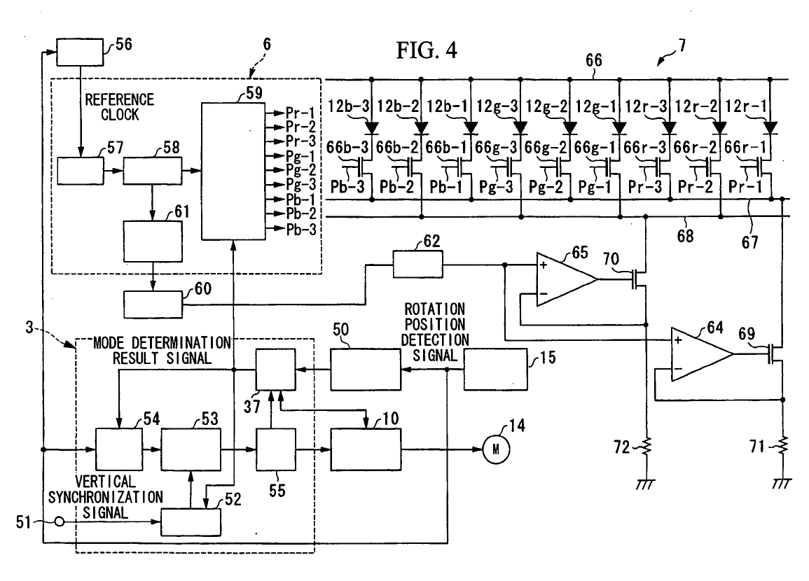

In the rotating optical system 11, as shown in FIG. 2, a plurality of R (red) color LEDs 12r (for example, 12r-1, 12r-2, 12r-3 in FIG. 4), a plurality of G (green) color LEDs 12g (for example, 12g-1, 12g-2, 12g-3 in FIG. 4), and a plurality of B (blue) color LEDs 12b (for example, 12b-1, 12b-2, 12b-3) are arranged in a circle opposite to the locus of an input end 13a of a rotating rod 13 which rotates.

Returning to FIG. 1, the rotating rod 13 is rotated by a motor 14. The rotation of the rotation rod 13 is detected by the rotation detection sensor 15. The rotation position detection signal from this rotation detection sensor 15 is supplied to the DMD drive control circuit 3 and is supplied to the PLL circuit 16. The reference clock is generated in the PLL circuit 16. This reference clock is supplied to the timing generation circuit 6.

Moreover, in the DMD drive control circuit 3, the number of revolutions and the phase of the rotation position detection signal from the rotation detection sensor 15 are compared with the cycle and phase of the vertical synchronization signal of the input video signal, and the motor driving signal is generated based on this comparison signal. Thus, rotation of the motor 14 is controlled to synchronize with the vertical synchronization signal of the input video signal, so that a required number of revolutions is achieved.

As a result of rotation of the motor 14, the input end 13a of the rotating rod 13 rotates above and along the plurality of LEDs 12r, 12g, and 12b arranged in a circle. Due to the rotation of the rotating rod 13, among the plurality of LEDs 12r, 12g, and 12b, the light of the LED present in a position corresponding to the position of the input end 13a of the rotating rod 13 is selectively taken in, and this light is guided from the output end 13b of the rotating rod 13.

The light from the rotating rod 13 is incident on a waveguide optical element 17, being a rod with an inverse tapered shape. The light output from the output end of the waveguide optical element 17 travels through an illumination system comprising illumination lenses 18a and 18b, a mirror 19, and a field lens 20, and it is then irradiated onto the surface of the DMD element 5 on which the minute mirrors are formed.

The angles of the minute mirrors on the surface of the DMD element 5 are changed by the DMD driving signal, thereby changing the path of the light. Therefore, the reflected light of the DMD element 5 is modulated by the DMD driving signal from the DMD drive control circuit 3 for each pixel. The light modulated by this DMD driving signal is magnified by a projection lens 21 and is projected on a projection surface 22 as projection light. As a result, an image is projected on the projection surface 22.

2. Video Signal Mode Determination

As described above, in a projector to which the present invention is applied, an RGB color video signal from a personal computer or the like, and an NTSC format signal can be inputted. For example, polarities, timing, and frequencies of a horizontal synchronization signal and a vertical synchronization signal of an analog RGB video signal from a personal computer, are defined according to the resolution of that output video signal by VESA (Video Electronics Standards Association) or the like. Moreover, some personal computers output a video signal having nonstandard polarity or timing in some cases.

Therefore so that a projector to which the present invention is applied can handle various types of video signal, including video signals having nonstandard polarity and timing, the resolution and refresh rate of the video signal being currently inputted are determined in the DMD drive control circuit 3 on the basis of the horizontal and vertical synchronization signals from the video signal processing circuit 2 (hereinafter referred to as mode determination), and various kinds of control are carried out according to the mode determination result.

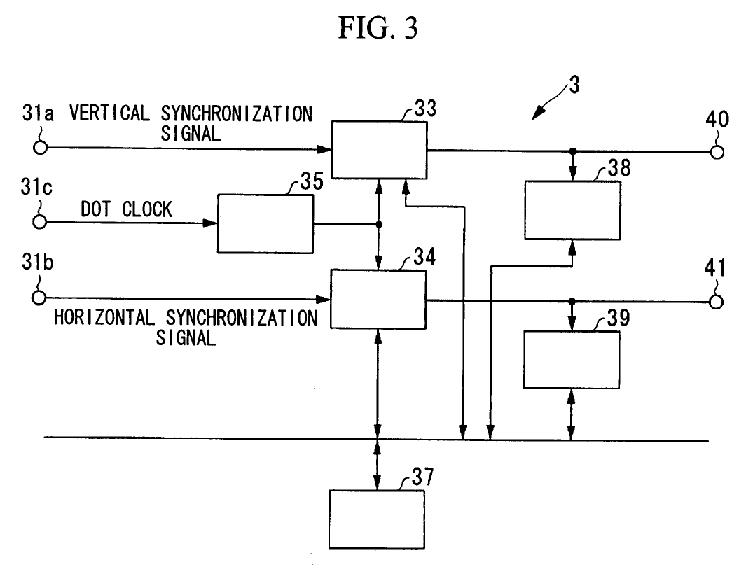

FIG. 3 shows an example of a video type detection circuit configured in the DMD drive control circuit 3. In FIG. 3, a vertical synchronization signal of an input video signal from the video signal processing circuit 2 is supplied to an input terminal 31a, and a horizontal synchronization signal of the input video signal is supplied to an input terminal 31b. A dot clock of the input video signal is supplied to an input terminal 31c. Here, the dot clock is a pixel clock set according to the panel resolution, and is generated in the PLL circuit (not shown in the diagram) from the horizontal synchronization signal.

The vertical synchronization signal from the input terminal 31a is supplied to a vertical synchronization adjustment circuit 33. The horizontal synchronization signal from the input terminal 31b is supplied to a horizontal synchronization adjustment circuit 34. The dot clock from the input terminal 31c is supplied to a divider 35. At the divider 35 the dot clock is divided and a sampling clock generated. This sampling clock is supplied to the vertical synchronization adjustment circuit 33 and the horizontal synchronization adjustment circuit 34.

In the vertical synchronization adjustment circuit 33, a vertical synchronization signal of an effective period is sampled by the sampling clock, which is the divided dot clock. The result of this sampling is transmitted to a CPU 37. Moreover, in the horizontal synchronization adjustment circuit 34, a horizontal synchronization signal of an effective period is sampled by the sampling clock, which is the divided dot clock. The result of this sampling is transmitted to the CPU 37.

The CPU 37 receives the sampling results of the vertical and horizontal synchronization signals, and from the ratio of that H level and L level, detects a duty ratio of the synchronization signals, and determines the polarity of the synchronization signal from the detected duty ratio. For example, in the case where the polarity of the synchronization signal that has been inputted has been determined to be negative, the CPU 37 controls the synchronization adjustment circuits 34 and 35 to invert the signals. The vertical synchronization adjustment circuit 33 and the horizontal synchronization adjustment circuit 34 change the polarities of the vertical and horizontal synchronization signals to positive and output them, based on the instruction from the CPU 37.

The signal that has been adjusted in the vertical synchronization adjustment circuit 33 is outputted from an output terminal 40, and transmitted to a vertical cycle measuring circuit 38. The time between a front edge of the vertical synchronization signal and the next front edge is found by the vertical cycle measuring circuit 38, by counting with a clock of a predetermined frequency. The count value between the front edges of the vertical synchronization signal is transmitted to the CPU 37.

The signal that has been adjusted in the horizontal synchronization adjustment circuit 34 is outputted from an output terminal 41 and transmitted to a horizontal cycle measuring circuit 39. The time between a front edge of the horizontal synchronization signal and the next front edge is found by the horizontal cycle measuring circuit 39, by counting with a clock of a predetermined frequency. The count value between the front edges of the horizontal synchronization signal is transmitted to the CPU 37.

The CPU 37 compares the count value between the front edges of the vertical synchronization signal from the vertical cycle measuring circuit 38 and the count value between the front edges of the horizontal synchronization signal from the horizontal cycle measuring circuit 39, with the count value between the front edges of the vertical synchronization signal of a prestored standard value data and the count value between the front edges of the horizontal synchronization signal of the prestored standard value data, and determines a suitable mode of the resolution.

For example, in the case where a synchronization signal having XGA resolution (1024 dots×768 lines), refresh rate 60 Hz, and dot clock 65 MHz is inputted, since the frequency of the horizontal synchronization signal is 48.5 Khz, the count value becomes “1340” taking the sampling clock as 65 MHz at a division ratio of 1. Similarly, since the frequency of the horizontal synchronization signal is 60 Hz, the count value becomes “1083”, taking sampling clock as 65 MHz at a division ratio of 1.

When the count value between the front edges of the horizontal synchronization signal from the horizontal cycle measuring circuit 39 is “1340”, and the count value between the front edges of the vertical synchronization signal from the vertical cycle measuring circuit 38 is “1083”, the CPU 37 determines the input video signal to be in XGA 60 Hz mode. Moreover, in consideration of the influences of jitter of the synchronization signals and sampling clocks, and of deviance from the standard signal, the determination range is set to have a margin.

As described above, in a projector to which the present invention is applied, the vertical synchronization signal and the horizontal synchronization signal are sampled, and from the duty ratio of H level and L level thereof, the polarity of the input video signal is determined. In the case where the polarity of the input video signal is negative, the signal is inverted to positive. Furthermore, the cycles of the vertical synchronization signal and the horizontal synchronization signal are measured to determine the format of the input video signal. As a result, the types of various kinds of video signals, including nonstandard video signals, can be determined.

3. LED Turn-on Control

In a projector to which the present invention is applied, as described above, the rotation detection sensor 15 detects rotation of the motor 14, and the PLL circuit 16 generates a reference clock from the rotation position detection signal from the rotation detection sensor 15, and the LED lighting pulse is generated according to this reference clock. Also, rotation of the motor 14 is controlled by the DMD drive control circuit 3 so that a desired number of revolutions can be attained in synchronization with the synchronization signal of the input video signal. LED lighting timing and rotation of the motor 14 are set according to the above mode determination result. FIG. 4 shows details of a circuit for performing such control. In the following description, a case is described where the red color LEDs 12r, the green color LEDs 12g, and the blue color LEDs 12b are respectively configured from three LEDs. However, this number of LEDs to be installed is an example and it is not limited to this. Furthermore, the number of LEDs to be installed may be changed with respect to each color.

In FIG. 4, the red color LEDs 12r (12r-l, 12r-2, 12r-3), the green color LEDs 12g (12g-1, 12g-2, 12g-3), and the blue color LEDs 12b (12b-1, 12b-2, 12b-3) are arranged in a circle as shown in FIG. 2.

FETs (Field Effect Transistor) 66r (66r-1, 66r-2, 66r-3), 66g (66g-1, 66g-2, 66g-3), and 66b (66b-1, 66b-2, 66b-3) for switching each LED are respectively provided for switching the LEDs 12r (12r-1, 12r-2, 12r-3), the LEDs 12g (12g-1, 12g-2, 12g-3), and the LEDs 12b (12b-1, 12b-2, 12b-3).

Anodes of the LEDs 12r (12r-1, 12r-2, 12r-3), the LEDs 12g (12g-1, 12g-2, 12g-3), and the LEDs 12b (12b-1, 12b-2, 12b-3) are connected to a power supply line 66. Cathodes of the LEDs 12r (12r-1, 12r-2, 12r-3), the LEDs 12g (12g-1, 12g-2, 12g-3), and the LEDs 12b (12b-1, 12b-2, 12b-3) are respectively connected to drains of the FETs 66r (66r-1, 66r-2, 66r-3), 66g (66g-1, 66g-2, 66g-3), and 66b (66b-1, 66b-2, 66b-3).

Lighting pulses Pr (Pr-1, Pr-2, Pr-3), Pg (Pg-1, Pg-2, Pg-3), and Pb (Pb-1, Pb-2, Pb-3) from a decoder 59 are respectively supplied to each of the gates of the FETs 66r (66r-1, 66r-2, 66r-3), 66g (66g-1, 66g-2, 66g-3), and 66b (66b-1, 66b-2, 66b-3). Sources of the alternate FETs 66r (66r-1, 66r-3), 66g (66g-1, 66g-3), and 66b (66b-1, 66b-3) are connected to a line 67, and sources of the other alternate FETs 66r (66r-2), 66g (66g-2), and 66b (66b-2) are connected to a line 68.

The drain of an FET 69 is connected to the line 67. The source of the FET 69 is connected to an inverting input terminal of an operational amplifier 64, and a resistor 71 is connected between the source of the FET 69 and ground.

The drain of an FET 70 is connected to the line 68. The source of the FET 70 is connected to an inverting input terminal of an operational amplifier 65, and a resistor 72 is connected between the source of the FET 70 and ground.

A PLL circuit 56 generates a reference clock based on the rotation position detection signal from the rotation detection sensor 15. This reference clock is supplied to a counter 58 via a divider 57. The count value from the counter 58 is supplied to the decoder 59. The decoder 59 generates lighting pulses Pr (Pr-1, Pr-2, Pr-3), Pg (Pg-1, Pg-2, Pg-3), and Pb (Pb-1, Pb-2, Pb-3) for controlling the lighting of each of the LEDs 12r (12r-1, 12r-2, 12r-3), the LEDs 12g (12g-1, 12g-2, 12g-3), and the LEDs 12b (12b-1, 12b-2, 12b-3), from the count value of the reference clock.

Moreover, optimum electric current value data for the LEDs of each color is stored beforehand in a ROM 60. An address for reading an optimum electric current value for the LEDs of each color is generated from an address generation circuit 61, based on the count value of the counter 58. The electric current setting data is then outputted from the ROM 60 based on this address. This electric current setting data is supplied to a D/A converter 62, and is converted into a set voltage of the electric current value by the D/A converter 62. This set voltage of the electric current value is supplied to a non-inverting input terminal of the operational amplifiers 64 and 65.

The decoder 59 outputs lighting pulses Pr (Pr-1, Pr-2, Pr-3), Pg (Pg-1, Pg-2, Pg-3), and Pb (Pb-1, Pb-2, Pb-3) that sequentially become H level in the light emitting period of each of the LEDs. For example, the FET 66r-1 is turned on as the lighting pulse Pr-1 becomes H level. As a result, electric current flows to the LED 12r-1, and the LED 12r-1 lights.

At this time, the electric current flowing to the LED 12r-1 is determined by the electric current flowing through the FET 69. A set voltage based on the electric current value setting data read from the ROM 60 is supplied to the non-inverting input terminal of the operational amplifier 64. The output voltage of the operational amplifier 64 is applied to the gate of the FET 69, and the source voltage of the FET 69 is feedback to the operational amplifier 64. Therefore, a voltage based on the electric current value setting data is applied to the gate of the FET 69, and the desired electric current flows to the FET 69. As a result, the desired driving electric current can be applied to the LED 12r-1.

Next, the FET 66r-2 is turned on as the lighting pulse Pr-2 becomes H level. As a result, electric current flows to the LED 12r-2, and the LED 12r-2 lights. At this time, the electric current flowing to the LED 12r-2 is determined by the electric current flowing through the FET 70. A set voltage based on the electric current value setting data read from the ROM 60 is supplied to the non-inverting input terminal of the operational amplifier 65. The output voltage of the operational amplifier 65 is applied to the gate of the FET 70, and the source voltage of the FET 70 is feedback to the operational amplifier 65. Therefore, a voltage based on the electric current value setting data is applied to the gate of the FET 70, and the desired electric current flows to the FET 70. As a result, the desired driving electric current can be applied to the LED 12r-2.

Thereafter, when the lighting pulses Pr (Pr-1, Pr-2, Pr-3), Pg (Pg-1, Pg-2, Pg-3), and Pb (Pb-1, Pb-2, Pb-3) sequentially become H level, the FETs 66r (66r-1, 66r-2, 66r-3), 66g (66g-1, 66g-2, 66g-3), and 66b (66b-1, 66b-2, 66b-3) are respectively turned on and the LEDs 12r (12r-1, 12r-2, 12r-3), the LEDs 12g (12g-1, 12g-2, 12g-3), and the LEDs 12b (12b-1, 12b-2, 12b-3) are turned on.

The lighting time of the respective LEDs 12r (12r-1, 12r-2, 12r-3), LEDs 12g (12g-1, 12g-2, 12g-3), and LEDs 12b (12b-1, 12b-2, 12b-3) can be set according to the mode determination result signal transmitted to the decoder 59 from the CPU 37 of the DMD drive control circuit 3.

Moreover, since the sources of alternate FETs 66r (66r-1, 66r-3), 66g (66g-1, 66g-3), and 66b (66b-1, 66b-3) are connected to a line 67, and sources of the other alternate FETs 66r (66r-2), 66g (66g-2), and 66b (66b-2) are connected to a line 68, a period for simultaneously lighting the adjacent LEDs can be set.

4. Motor Control

Next, motor control is described. In FIG. 4, the vertical synchronization signal of the input video signal is supplied to the input terminal 51. The vertical synchronization signal from the input terminal 51 is supplied to a phase comparator 53 via a divider 52. Moreover, the rotation position detection signal from the rotation detection sensor 15 is supplied to the phase comparator 53 via a divider 54.

The phase comparator 53 compares the phase of the vertical synchronization signal supplied through the divider 52 with the phase of the rotation position detection signal supplied through the divider 54. This phase comparison output is supplied to a motor driving circuit 10 via a low pass filter 55, and the motor 14 is rotated by the motor driving circuit 10.

Rotation of the motor 14 is detected by the rotation detection sensor 15. This rotation position detection signal is returned to the phase comparator 53 via the divider 54. Moreover, the rotation position detection signal of the rotation detection sensor 15 is supplied to a number of revolutions detection circuit 50. The number of revolutions of the motor 14 is detected in the number of revolutions detection circuit 50. This number of revolutions is supplied to the CPU 37 and is compared with a target number of revolutions by the CPU 37. Consequently, the rotation of the motor 14 is controlled so that a required number of revolutions that synchronizes with the vertical synchronization signal of the input video signal is achieved. Moreover, by appropriately setting the dividing ratios of the divider 52 and the divider 54, a relationship between the phase of the vertical synchronization signal and the rotation phase of the motor 14 can be set.

5. Lighting Control for Each Mode

In a projector to which the present invention is applied, a plurality of video signals of differing horizontal frequencies and vertical frequencies can be inputted. Based on the mode determination result mentioned above, the emission of the LED lights is controlled as described below.

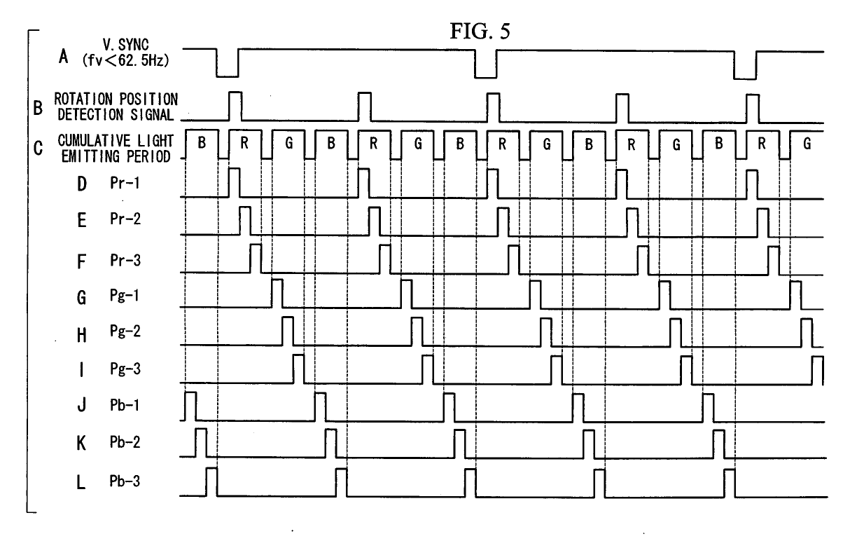

FIG. 5 shows an example of light emission timing of each LED in the case where the vertical frequency fv of the input video signal is satisfies fv <62.5 Hz. Here, in order to simplify the description, each of the RGB LEDs 12r, 12g, and 12b uses three LEDs, so that nine LEDs are used in total, and the light emitting period of each of the LEDs 12r, 12g, and 12b is equal.

As described above, in a projector to which the present invention is applied, cycles of the vertical synchronization signal and the horizontal synchronization signal are measured, and the input video signal format determined, to carry out mode determination.

In the case where the vertical frequency fv of the input video signal is determined to be fv =60 Hz as a result of this mode determination, the rotation of the motor 14 is controlled so that the motor 14 rotates four times within the period of two vertical cycles of the input video signal (A of FIG. 5) as shown in B of FIG. 5. In the timing generation circuit 6, as shown in D to L of FIG. 5, the lighting pulses Pr-1 tb Pr-3, Pg-1 to Pg-3, and Pb-1 to Pb-3 are generated so that each of the LEDs 12r-1 to 12r-3, 12g-1 to 12g-3, and 12b-1 to 12b-3 sequentially lights four times recursively within the period of two vertical cycles (33.3 mS).

The FETs 66r-1 to 66r-3, 66g-1 to 66g-3, and 66b-1 to 66b-3 for switching, connected to each of the LEDs 12r-1 to 12r-3, 12g-1 to 12g-3, and 12b-1 to 12b-3 are turned on by these lighting pulses Pr-1 to Pr-3, Pg-1 to Pg-3, and Pb-1 to Pb-3, and each of the LEDs 12r-1 to 12r-3, 12g-1 to 12g-3, and 12b-1 to 12b-3 then sequentially lights.

Here, the lighting time of each of the LEDs 12r-1 to 12r-3, 12g-1 to 12g-3, and 12b-1 to 12b-3 depends on the pulse widths of the lighting pulses Pr-1 to Pr-3, Pg-1 to Pg-3, and Pb-1 to Pb-3.

For example, in the case where the pulse widths of the lighting pulses Pr-1 to Pr-3, Pg-1 to Pg-3, and Pb-1 to Pb-3 are 0.85 mS respectively, since the nine LEDs respectively light four times within the period of two vertical cycles, the cumulative lighting time of the LEDs within two vertical cycles is 0.85×9×4=30.6 mS.

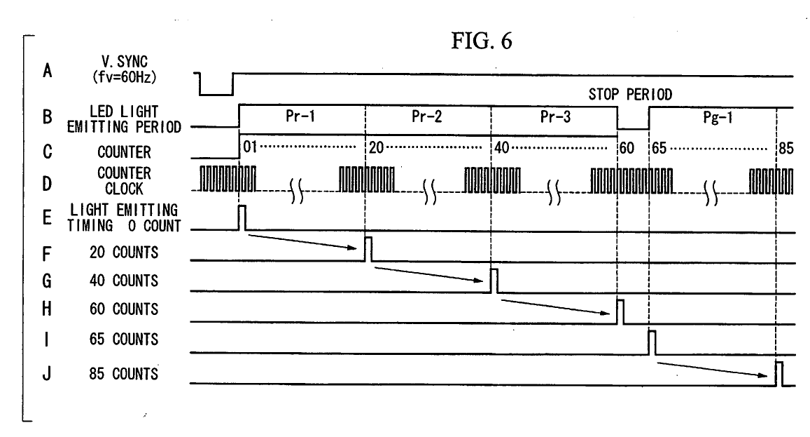

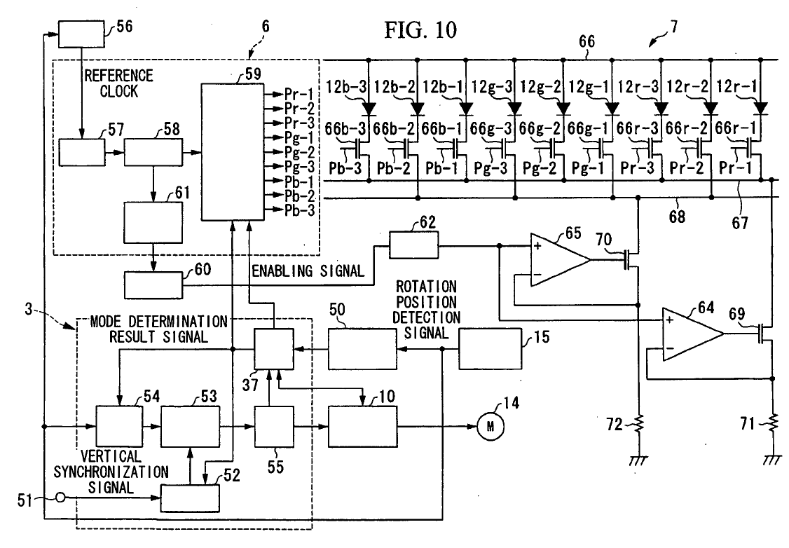

In practice, as shown in FIG. 6, the emission period for which one LED pulse-lights is a time interval further divided by several tens (divided by twenty in FIG. 10). That is, within the vertical period of fv=60 Hz as shown in A of FIG. 6, lighting pulses Pr-1 and Pr-2 are set as shown in B of FIG. 6. As shown in C of FIG. 6, the counter clock is counted twenty times within one lighting pulse period. As shown in E to J of FIG. 6, a pulse that indicates start is outputted at a start timing of the light emitting period of each lighting pulse.

Here, within one rotation, since lighting is carried out 195 times in total, that is, twenty times within the period of lighting pulse Pr-1, twenty times within the period of lighting pulse Pr-2, and twenty times within the period of lighting pulse Pr-3, and 180 times in total for all RGBs, where stop periods between RGBs correspond to the time of five respective lightings, then,
1/{(1/120 Hz)/195}=23.4 KHz,
and the frequency of a counter clock of pulse lighting (D of FIG. 6) becomes 23.4 KHz.

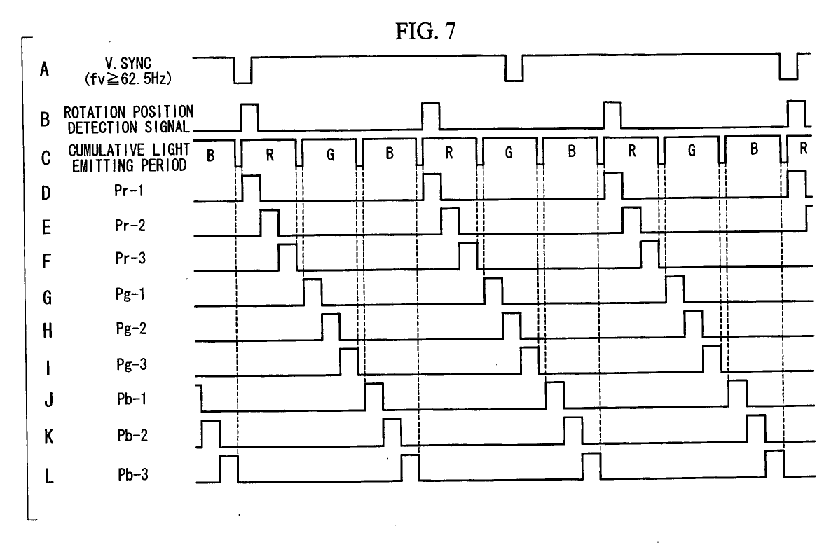

Similarly, FIG. 7 shows the light emitting timing of each LED in the case where the vertical frequency fv of the input video signal is satisfies fv≧62.5 Hz.

In the case where the vertical frequency fv of the input video signal is determined to be fv=75 Hz as a result of mode determination, the rotation of the motor 14 is controlled so that the motor 14 rotates three times within the period of two vertical cycles of the input video signal as shown in B of FIG. 7. Then, in the timing generation circuit 6, as shown in D to L of FIG. 7, the lighting pulses Pr-1 to Pr3, Pg-1 to Pg3, and Pb-1 to Pb3 are generated so that each of the LEDs 12r-1 to 12r-3, 12g-1 to 12g-3, and 12b-1 to 12b-3 sequentially lights three times recursively within the period of two vertical cycles (26.6 mS).

The FETs 66r-1 to 66r-3, 66g-1 to 66g-3, and 66b-1 to 66b-3 for switching, connected to each of the LEDs 12r-1 to 12r-3, 12g-1 to 12g-3, and 12b-1 to 12b-3 are turned on by these lighting pulses Pr-1 to Pr-3, Pg-1 to Pg-3, and Pb-1 to Pb-3, and each of the LEDs 12r-1 to 12r-3, 12g-1 to 12g-3, and 12b-1 to 12b-3 then sequentially lights.

In this case, since the motor 14 rotates three times within the period of two vertical cycles, it rotates at 112.5 Hz. For example, in the case where pulse width of each of the LEDs 12r-1 to 12r-3, the LEDs 12g-1 to 12g-3, and the LEDs 12b-1 to 12b-3 of RGB is 0.91 mS, the nine LEDs respectively light three times within the period of two vertical cycles, and the cumulative lighting time of the LEDs within two vertical cycles is found from the following equation.
0.91×9×3=24.57 mS

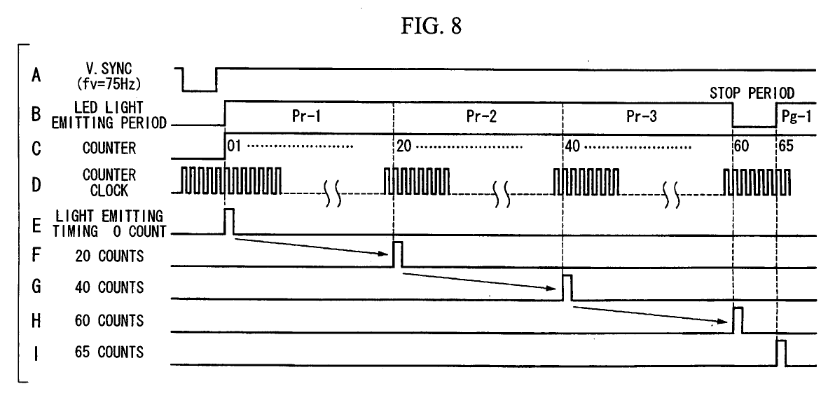

In practice, as shown in FIG. 8, the emission period for which one LED pulse-lights is a time interval further divided by several tens (divided by twenty in FIG. 10). Specifically, within the vertical period of fv=75 Hz as shown in A of FIG. 8, lighting pulses Pr-1 and Pr-2 are set as shown in B of FIG. 8. As shown in C of FIG. 8, the counter clock is counted twenty times within one lighting pulse period. As shown in E to I of FIG. 8, a pulse that indicates start is outputted at the start timing of the light emitting period of each lighting pulse. Within one rotation, since lighting is carried out 195 times in total, that is, twenty times within the period of lighting pulse Pr-1, twenty times within the period of lighting pulse Pr-2, and twenty times within the period of lighting pulse Pr-3, and 180 times in total for all RGB, where stop periods between RGB correspond to the time of five respective lightings, then,
1/{(1/112.5 Hz)/195}=21.9 KHz,
and the clock frequency of pulse lighting becomes 21.9 KHz.

Furthermore, in this example, the count value is fixed and the clock frequency is changed in order to control LED lighting width. However, the clock frequency may be fixed and the count value changed.

Thus, in a projector to which the present invention is applied, by taking a period of two vertical cycles of the input video signal as a unit and controlling the number of light emission times and the light emission duration of the LEDs within this period of two vertical cycles, a total light emission amount of the light source within the period of two vertical cycles becomes substantially equal. As a result, when various kinds of video signals are switched, luminance variance does not occur.

6. Motor Rotation Control for Each Mode

As described above, in the projector to which the present invention is applied, as shown in FIG. 4, the phase of the vertical synchronization signal of the input video signal through the divider 52 is compared with the phase of the rotation position detection signal through the divider 54, and the rotation speed of the motor 14 is controlled according to this comparison output so that the motor 14 rotates at a desired number of revolutions that is synchronized with the vertical synchronization signal of the input video signal. When the mode is switched, the divider 52 and the divider 54 are appropriately set accordingly. For light emission of the LED, the light emitting diodes are controlled so that the light emission amount becomes substantially equal across units of the period of two vertical cycles of the input video signal as described above. Rotation of the motor 14 is controlled so that, taking the period of two vertical cycles as a unit, the motor 14 rotates an integral number of times within the two vertical periods.

7. Control when Rotation of the Motor is not Stable

Incidentally, the motor 14 requires a period of time from startup of the motor 14 until the rotation speed of the motor 14 reaches a predetermined speed that is synchronized with the vertical synchronization signal of the input video signal.

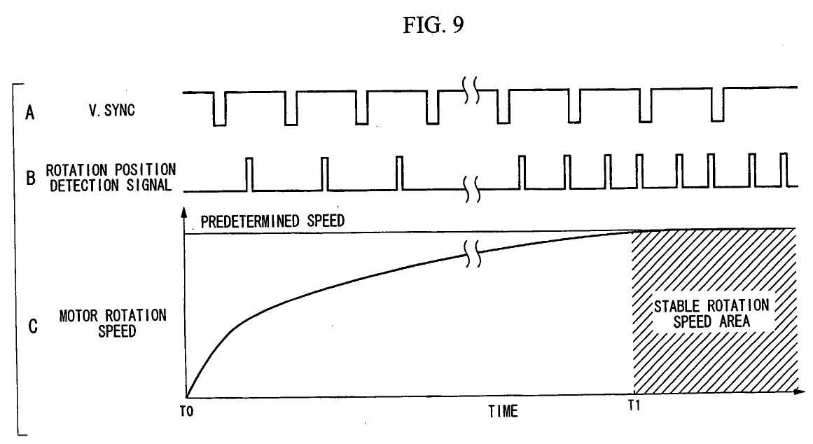

FIG. 9 shows a transition of rotation speed of the motor 14. In FIG. 9, once the motor 14 starts at time T0, the rotation speed of the motor 14 gradually increases as shown C in FIG. 9. The vertical synchronization signal of the input video signal (A of FIG. 9) is compared with the phase of the rotation position detection signal (B of FIG. 9), and rotation of the motor 14 is controlled according to this phase error. From time T0 to T1, the number of revolutions of the motor 14 has not reached the desired number of revolutions, and the phase error between the phase of the vertical synchronization signal of the input video signal and the phase of the rotation of the motor is large, and the rotation of the motor 14 is not stable. At time T1, the number of revolutions of the motor 14 has reached the desired number of revolutions, and the phase error between the phase of the vertical synchronization signal of the input video signal and the phase of the rotation of the motor becomes small, and the motor 14 starts to rotate stably.

Thus, the rotation of the motor 14 is not stable during the time between startup of the motor 14 and the time at which the rotation speed of the motor 14 becomes stable (T0 to T1). Thus, if the LEDs are lighted to display an image while the rotation speed of the motor 14 is not stable, the image is displayed with disturbed colors.

Consequently, in a projector to which the present invention is applied, the number of revolutions detection circuit 50 for detecting the number of revolutions of the motor is provided as shown in FIG. 10. Detection output from this number of revolutions detection circuit 50 is supplied to the CPU 37.

The CPU 37 determines whether or not the rotation of the motor 14 has become stable, from the detection output from this number of revolutions detection circuit 50, and performs processing to turn off the LEDs while the motor 14 is not stable.

That is to say, as shown in FIG. 10, the CPU 37 determines whether or not rotation of the motor 14 is stable based on the detection output from the number of revolutions detection circuit 50, and according to this, transmits an enabling signal to the decoder 59. When the motor 14 has reached a predetermined number of revolutions and the rotation of the motor 14 is stable, the enabling signal is transmitted from the CPU 37 to the decoder 59, and each of the LEDs 12r (12r-1, 12r-2, 12r-3), 12g (12g-1, 12g-2, 12g-3), and 12b (12b-1, 12b-2, 12b-3) sequentially lights at a predetermined timing.

When the number of revolutions of the motor 14 has not reached the predetermined number of revolutions, the enabling signal from the CPU 37 is stopped. At this time, the decoder 59 makes the lighting pulses Pr-1 to Pr-3, Pg-1 to Pg-3, and Pb-1 to Pb-3 all L level, and all of the LEDs 12r (12r-1, 12r-2, 12r-3), 12g (12g-1, 12g-2, 12g-3), and 12b (12b-1, 12b-2, 12b-3) are turned off.

Moreover, in this example, the CPU 37 transmits the enabling signal to the decoder 59, and the turn-on/turn-off of the LEDs is controlled by this enabling signal. However, LED turn-on/turn-off control is not limited to this.

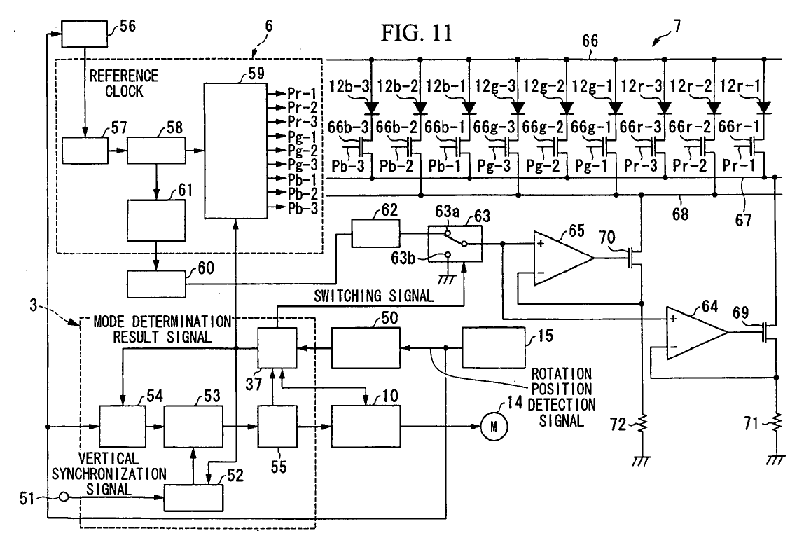

FIG. 11 shows another example of LED turn-on/turn-off control. In FIG. 11, the detection output from the number of revolutions detection circuit 50 is transmitted to the CPU 37. The CPU 37 transmits a switching signal to a switch circuit 63 based on the detection output from the number of revolutions detection circuit 50.

When the number of revolutions of the motor 14 is equal to or greater than the predetermined value, the switch circuit 63 is set to a contact point 63a side by the switching signal from the CPU 37. At this time, the driving electric current for the LEDs is set based on the electric current value setting data read from the ROM 60, and each of the LEDs 12r (12r-1, 12r-2, 12r-3), 12g (12g-1, 12g-2, 12g-3), and 12b (12b-1, 12b-2, 12b-3) sequentially lights at a predetermined timing.

When the number of revolutions of the motor 14 is determined to be less than the predetermined value, the switch circuit 63 is set to a contact point 63b side by the switching signal from the CPU 37. When the switch circuit 63 is set to the contact point 63b side, the non-inverting input terminals of the operational amplifiers 64 and 65 are grounded, and the FETs 64 and 65 are then turned off. Consequently, all of the LEDs 12r (12r-1, 12r-2, 12r-3), the LEDs 12g (12g-1, 12g-2, 12g-3), and the LEDs 12b (12b-1, 12b-2, 12b-3) are turned off.

Instead of using the switch circuit 63, the ROM 60 may output an electric current value setting data of “0” when rotation of the motor 14 is not stable.

8. Noise Countermeasures and Power Saving

Incidentally, rotation of the motor 14 does not reach the desired number of revolutions in some cases due to influence of noise and so forth. Also, rotation of the motor 14 does not reach the desired number of revolutions in some cases due to a fault. In this case, if rotation of the motor 14 is continued, then electric power is unnecessarily consumed.

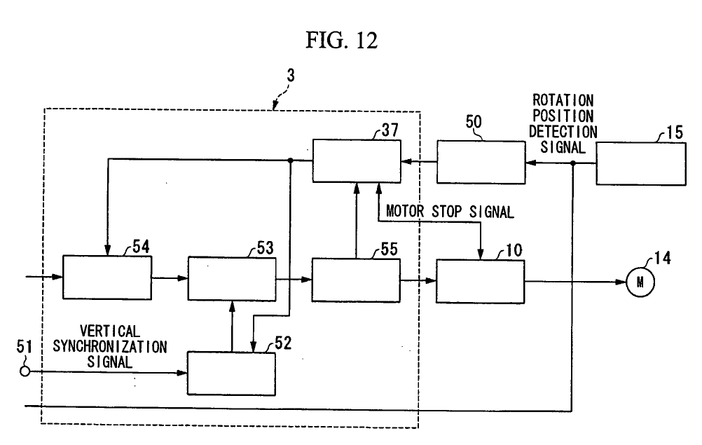

In a projector to which the present invention is applied, when the motor 14 does not reach the predetermined number of revolutions, the motor 14 is turned off. That is, as shown in FIG. 12, the number of revolutions detection circuit 50 that detects the number of revolutions of the motor is provided. Detection output from this number of revolutions detection circuit 50 is supplied to the CPU 37. The CPU 37 determines whether or not the number of revolutions of the motor 14 has reached a predetermined number of revolutions, from the detection output of the number of revolutions detection circuit 50. Then, when the number of revolutions of the motor 14 has not reached the predetermined number of revolutions, the CPU 37 transmits a motor stop signal to the motor driving circuit 10, and the rotation of the motor 14 is stopped.

9. Motor Rotation Processing when no Signals are Present

Incidentally, in a projector to which the present invention is applied, as described above, the rotation of the motor 14 is controlled based on the output of the phase comparison between the vertical synchronization signal through the divider 52 and the rotation position detection signal through the divider 54. As a result, when no input signal is present, the vertical synchronization signal cannot be obtained and the motor 14 cannot be controlled.

Stopping the rotation of the motor 14 may be considered when no input signal is present. However, if the motor stops, then there will be a need for a period of time for controlling the rotation of the motor 14 to reach the desired number of revolutions when a next video signal is inputted.

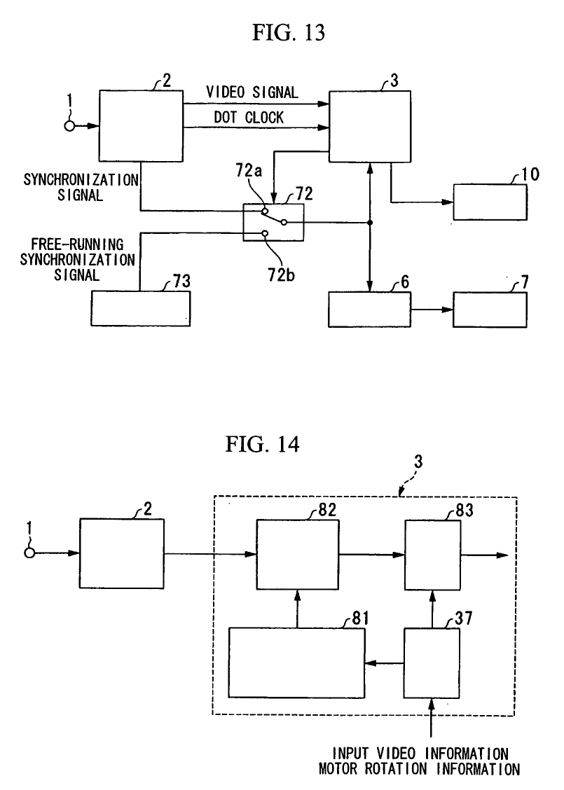

Consequently, in a projector to which the present invention is applied, as shown in FIG. 13, a free running vertical synchronization signal generation circuit 73 that generates, for example, a 60 Hz fixed free running vertical synchronization signal, is provided, and the output signal of this free running vertical synchronization signal generation circuit 73 is supplied to a contact point 72b of a switch circuit 72. The switch circuit 72 is usually set to a contact point 72a side. In the case where absence of an input video signal has been determined by the mode determination in the DMD drive control circuit 3, the switch circuit 72 is switched to the contact point 72b side by the switch control signal from the DMD drive control circuit 3, and this free running vertical synchronization signal is supplied to the timing generation circuit 6 and DMD drive control circuit 3. As a result, even in the case where an input signal is not present, the motor 14 is controlled to rotate stably at, for example, 120 Hz. Moreover, the LED light emitting timing is set based on this timing.

Furthermore, in this example, when an input signal is absent, a free running vertical synchronization signal of a fixed rate from the free running vertical synchronization signal generation circuit 73 is used. However, a free running vertical synchronization signal of the rate of a previous vertical synchronization signal may be generated to be used when an input signal is not present.

10. Image Processing when Input Signal is Absent

Moreover, in the case where an input signal is absent or discontinued, if LEDs are turned on and display is carried out, the screen will have a disturbed display. Also, if the LEDs are turned off, the screen will black out and the OSD display cannot be seen. In this case, for example, a message indicating “there is no input” needs to be displayed by the OSD to advise a user of this information.

Similarly, the rotation of the motor 14 may temporarily not reach the predetermined number of revolutions when switching the input video signal. In this case, a message to the effect of “please wait for a while” needs to be displayed by the OSD. Furthermore, it is assumed that the motor 14 becomes unable to rotate stably at the predetermined number of revolutions in the case of some kind of breakdown. In this case, a message to the effect of “please contact the service center” needs to be displayed by the OSD.

Consequently, in a projector to which the present invention is applied, in the case where an input video signal is absent, or rotation of the motor 14 differs from the usual, a masking signal or fixed pattern is generated in the DMD drive control circuit 3, and this masking signal or fixed pattern is displayed.

That is, as shown in FIG. 14, for example a fixed pattern generation circuit 81 that generates a fixed pattern with a blue background is provided. The fixed pattern signal from this fixed pattern generation circuit 81 is supplied to a signal synthesis/switching circuit 82. The DMD drive control circuit 3 includes an OSD circuit 37 that overlays and displays various kinds of information on an image.

Usually, a video signal from the video signal processing circuit 2 is transmitted into the DMD drive control circuit 3 through the signal synthesis/switching circuit 82. In the case where an input video signal is absent, or the rotation of the motor 14 differs from the usual, a fixed pattern signal from the fixed pattern generation circuit 81 is outputted through the signal synthesis/switching circuit 82, and the fixed pattern signal replaces the input video signal. As a result, a blue background image is displayed, and information from the OSD circuit 37 is displayed on this blue background image screen.

Moreover, in this example, the displayed data is a blue background. However, it is not limited to a blue background. As long as its purpose is power saving, a RG raster or any user-defined image may be displayed.

Furthermore, in the present working example, the case where data conversion is carried out for an A/D-converted digital video signal from the video signal processing circuit 2, has been described. However, it may be configured such that an analog video signal, which has not yet been A/D converted, is masked so as not to output display data (all black display).

What is claimed is:

1. A light source device comprising:
a video type detection section that detects a type of an input video signal;
a plurality of light emitting diodes that irradiate illumination light; and
a lighting control section that controls a lighting status of the light emitting diodes, wherein
the lighting control section performs lighting control of the light emitting diodes, based on a type of a video signal as detected by the video type detection section.

2. A light source device according to claim 1, wherein the video type detection section extracts a synchronization signal of the input video signal, and determines the type of the input video signal, based on the cycle of the synchronization signal of the input video signal.

3. A light source device according to claim 1, wherein the video type detection section extracts a synchronization signal of the input video signal, and determines the type of the input video signal, based on a duty ratio of the synchronization signal of the input video signal.

4. A light source device according to claim 1, comprising:
an optical rod that takes in illumination light irradiated from a plurality of light emitting diodes arranged in a circle;
a motor that rotates the optical rod; and
a rotation control section that controls the rotation of the motor, wherein
the rotation of the optical rod is controlled based on a detection output of the video type detection section.

5. A light source device according to claim 4, wherein the rotation control section controls the motor so that the optical rod rotates an integral number of times within a period of two vertical cycles, taking a two vertical cycles period of the input video signal as a unit.

6. A light source device according to claim 4, wherein the lighting control section controls the light emitting diodes so that an emitted light amount becomes substantially equal across units of the period of two vertical cycles of the input video signal.

7. A light source device according to claim 4, wherein
the rotation control section has a detection section that detects a tracking status of rotation of the rod with respect to a synchronization signal,
and the plurality of the light emitting diodes are turned off in a case where the detection section has determined that a number of revolutions of the optical rod is below a predetermined number of revolutions.

8. A light source device according to claim 1, wherein the lighting control section controls timing for turning on the light emitting diodes, and lighting time duration of the light emitting diodes, based on the type of the video signal.

9. A light source device according to claim 1, wherein
the lighting control section has a free running vertical synchronization signal generation section that generates a free running vertical synchronization signal having a fixed rate or a rate of a previous video signal,
and in a case where an input signal is not present, the optical rod is rotated based on the free running vertical synchronization signal from the free running vertical synchronization signal generation section.

10. A light source device according to claim 1, wherein the rotation control section stops rotation of the optical rod when rotation of the optical rod is not stable.

11. A projection optical device comprising:
a video type detection section that detects a type of an input video signal;
a plurality of light emitting diodes that irradiate illumination light;
a lighting control section that controls a lighting status of the light emitting diodes;
a driving signal control section that generates a driving signal based on an input video signal; and
a spatial light modulation element that is driven by a driving signal from the driving signal control section, wherein
the lighting control section performs lighting control of the light emitting diodes based on a type of a video signal detected by the video type detection section.

12. A projection optical device according to claim 11, comprising
a detection section that detects a tracking status of rotation of an optical rod with respect to a synchronization signal,
and in a case where an input video signal is not present, or where the detection section has determined a number of revolutions of the optical rod to be unusual, a predetermined image is projected on the spatial light modulation element regardless of a synchronization signal status.
